(19) United States
(12) Patent Application Publication
(10) Pub. No.: US 2002/0087958 A1
(43) Pub. Date: Jul. 4, 2002

(54) Method and apparatus of transforming a class

(75) Inventor: Jens Krause, Thalwil (CH)

Correspondence Address: Gregory M. Doudnikoff, IBM Corporation T81//503, Research, PO Box 12195, Triangle Park, NC, 27709, US

(73) Assignee: International Business Machines Corporation, Armonk, NY (US)

(21) Appl. No.: 09/838,478

(22) Filed: Apr. 19, 2001

(30) Foreign Application Priority Data
Apr. 20, 2000 (EP) 108596.8

(51) Int. Cl. G06F 9/44

(52) U.S. Cl. 717/166

(57) ABSTRACT

A method and apparatus of transforming a class is disclosed. The class is split and converted into a modified class and/or a helper class. After the transformation, a safe class sharing among several processes is achieved whereby the startup times and the memory usage for the processes are reduced. The inter-process communication (IPC) becomes faster. The proposed mechanism is particularly suited and efficient in an object-oriented environment, such as Java.

### BACKGROUND OF THE INVENTION

1. Field of the Invention

The present invention generally relates to object-oriented programming and more specifically to transforming a class.

2. Description of the Related Art

Computer systems typically include operating system software that controls the basic function of a computer, and one or more software application programs that run under the control of the operating system to perform desired tasks. As the capabilities of computer systems have increased, the application software programs designed for high performance computer systems have become extremely powerful. Additionally, software development costs have continued to rise because more powerful and complex programs take more time, and hence more money, to produce.

One way in which the performance of application software programs has been improved while the associated development costs have been reduced is by using object-oriented programming concepts. The goal of using object-oriented programming is to create small, reusable sections of program code known as “objects”0 that can be quickly and easily combined and reused to create new programs. This is similar to the idea of using the same set of building blocks again and again to create many different structures. The modular and reusable aspects of objects will typically speed development of new programs, thereby reducing the costs associated with the development cycle. In addition, by creating and reusing a comprehensive set of well-tested objects, a more stable, uniform, and consistent approach to developing new computer programs can be achieved.

Another central concept in object-oriented programming is the “class”. A class is a template or prototype that defines a type of object. A class outlines or describes the characteristics or makeup of objects that belong to that class. By defining a class, objects can be created that belong to the class without having to rewrite the entire definition for each new object as it is created. This feature of object-oriented programming promotes the reusability of existing object definitions and promotes more efficient use of code.

“Java”0 is the name of a well-known and popular object-oriented computer programming language which is used to develop software applications. Java's popularity stems in part from its relative simplicity and the fact that Java is written in a manner that allows different computers (i.e., platforms) to execute the same Java code. In other words, Java is platform-independent. This feature has caused the use of Java to greatly increase with the growing popularity of the Internet, which allows many different type of computer platforms to communicate with each other.

The execution of multiple, mutually distrusting applications or multiple instances of the same application for different users in a Java Virtual Machine, also abbreviated as JVM, requires a form of multiprocessing which protects the integrity of the JVM as well as the integrity of individual applications. Known solutions protect processes by loading application classes in dedicated process class loaders and by allowing sharing of only the core Java classes between processes. These techniques are costly in terms of memory consumption, startup time and inter-domain communication. Thus, there is a need for a new approach which overcomes these limitations.

Multiprocessing support is needed to perform resource management, i.e., to prevent a single application from exhausting the available memory, network bandwidth or storage. There are no default facilities in so-called off-the-shelf JVMs that support these capabilities. In the Internet, there is a trend to execute foreign and therefore untrusted code. One way to circumvent the lack of multiprocessing support in Java is to start a separate JVM for each application and to rely on the underlying operating system for those services. However, this comes at a cost. A JVM consumes significant amounts of memory, the JVM startup time adds to the application startup time, and the communication between applications causes process context switches in the underlying operating system. Furthermore, there are small devices such as the Palm Pilot where the operating system does not support multiprocessing.

Single-address-space systems, as described by B. N. Bershad, S. Savage, P. Pardyak et al: Extensibility, Safety, and Performance in the SPIN Operating System, In Proceedings of the 15th ACM Symposium on Operating Systems Principles, 1995, use software mechanisms to provide protection. A type-safe language guarantees that references to objects cannot be forged, e.g., one cannot get hold of an object by casting an integer value into an object reference. In Java, type-safety is enforced through byte code verification, explicit casting, and type-checking.

Several projects, e.g., Dirk Balfanz and Li Gong: Experience with Secure Multi-Processing in Java, Princeton University, Technical Report 560-97, September 1997; Patrick Tullmann and Jay Lepreau: Nested Java Processes: OS Structure for Mobile Code, Proceedings of the Eighth ACM SIGOPS European Workshop, Sintra, Portugal, September 1998; or Chris Hawblitzel, Chi-Chao Chang, Grzegorz Czajkowski, Deyu Hu, and Thorsten von Eicken: Implementing Multiple Protection Domains in Java, 1998 Usenix Annual Technical Conference, use Java's type safety to provide protection for Java processes. They all suffer from the same Java characteristic: static fields, also referred to as class variables or class fields, which have global variable semantics in Java and are accessible to all processes sharing the class in which the static field is declared. Therefore, static fields can be used to retrieve references to objects of other processes and thus to bypass process boundaries. To solve this problem, the mentioned projects propose the creation of separate class name spaces for processes. The consequences are increased memory consumption and longer startup times, both due to separate class loading and just-in-time compilation. Further, the inter-process communication (IPC) mechanisms suffer from an overhead introduced by the use of Java's serialization mechanism for arguments and return values.

### SUMMARY OF THE INVENTION

One another object of the present invention is to provide a mechanism which allows a safe class sharing of application classes between processes even in the presence of static fields.

Another object of the present invention is to reduce the per-process memory requirements.

A still further object of the present invention is to speed up process startup times.

Yet another object of the present invention is to provide faster inter-process communication (IPC).

The objects of the invention are achieved by the features stated in the enclosed independent claims. Further advantageous implementations and embodiments of the invention are set forth in the respective subclaims.

The invention provides a mechanism of transforming a class. After the transformation, a safe class sharing among several processes is achieved. The mechanism is particularly suited for an object-oriented environment, such as Java.

The basic idea of the invention is to transform a class or an original class into at least two classes, in other words the original class is split into a helper class and a modified class, also referred to a modified-original class. The original class comprises static fields, also referred to as class fields, a class-initializer method, also referred to as class-initialization method, and/or class or usage methods. The modified class, as a non-static part, contains instance fields and all usage methods while the helper class, as a static part, contains the former static fields of the original class. The static fields of the original class are transformed into instance fields in the helper class. During runtime, one instance of the helper class is created at least for each process using that modified-original class. Thus, the semantics of the static fields of the original class become those of process-global variables. Because modified classes and helper classes do not contain static fields they can be shared securely.

Each static field in the original class is replaced in the modified class with, for example, two (static) access methods, also referred to as access functions, one for read and one for write access to the former static field which then is an instance field of the corresponding helper class. An access function first retrieves the instance of the helper class assigned with the current process and then reads or writes the instance variable for which it acts as a replacement.

The functionality of the class-initializer method of the original class is displaced into the constructor, i.e., the instance-initializer method, of the helper class, since the transformed static fields should be initialized for each process separately.

The splitting of the original classes causes broken references in static field accesses not only in the modified-original class but also in other classes that accessed static fields of the original class. Therefore, static field accesses in all application classes are replaced by method invocations of the corresponding access functions.

In reality, the transformed classes can be shared in the system class loader or another jointly used class loader whereby the static fields of the original classes end up as process-global variables with separate copies in each process. Thus, a fast copy mechanism for inter-process communication (IPC) can be used for arbitrary argument types.

In general, the transformed classes, i.e. the helper and modified classes, show several advantages compared with the original or untransformed classes, such as the startup times for the processes can be reduced. Moreover, the per-process memory consumption can be reduced, and the inter-process communication (IPC) becomes faster while the isolation property of a single process is maintained.

The transformation can be applied to a byte code, e.g. Java byte code, and is therefore very efficient, since the original code does not need to be rewritten. A safe sharing of application classes between processes even in the presence of static fields can be achieved. In particular, for Java applications this means that a safe class sharing among Java processes is achievable.

The mechanism of transforming a class is beneficial to applications on both sides of the client-server programming model. Server-side applications can run for different users with different privileges and nevertheless share the application code. On the client side, different applications can run simultaneously in the same Java Virtual Machine, also abbreviated as JVM, without interfering with each other. The mentioned savings can be realized if different applications use the same library, e.g. a graphics or algorithmic package.

It proves advantageous that the class loading performance of different JVM implementations decreases with an increasing number of classes already loaded. Also, the number of loaded classes can be reduced significantly when the same application is run multiple times in parallel.

### BRIEF DESCRIPTION OF THE DRAWINGS

The invention is described in detail below with reference to the following schematic drawings. All the figures are for the sake of clarity, not shown in real dimensions, nor are the relations between the dimensions shown in a realistic scale.

FIG. 1 shows a block diagram of an apparatus according to a preferred embodiment of the present invention.

FIG. 2 shows a schematic diagram of a transformation according to the present invention.

FIG. 3 shows a schematic transformation of a sample code of an original class into a helper class and a modified-original class.

FIG. 4 shows a schematic transformation of an example method of a class.

FIG. 5 shows a schematic diagram of a transformation according to the present invention applied to an interface.

FIG. 6 shows a schematic transformation of a sample code of an interface into a modified interface and a helper class.

FIG. 7. shows a schematic transformation of accesses to class fields of interfaces.

### DESCRIPTION OF THE PREFERRED INVENTION

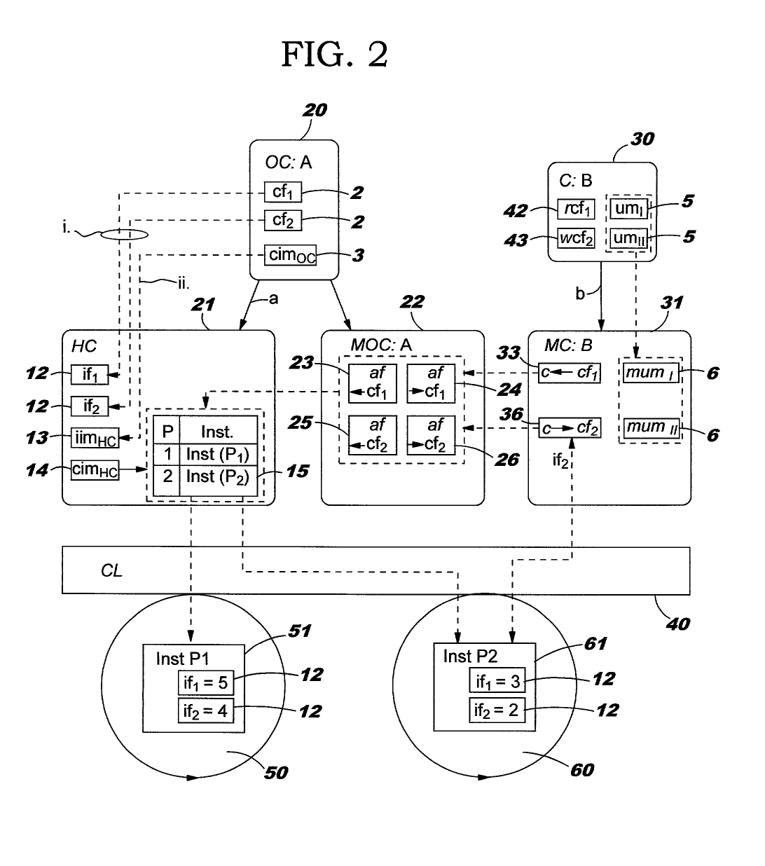

With general reference to the figures and with special reference to FIG. 2, the essential features of transforming a class is described in more detail below. At first, some general points are addressed.

Object-oriented programming is a method of program implementation in which programs are organized as cooperative collections of objects, each of which represents an instance of some class, and whose classes are all members of a hierarchy of classes united via inheritance relationships. Object-oriented programming differs from standard procedural programming in that it uses objects, not algorithms, as the fundamental building blocks for creating computer programs. This difference stems from the fact that the design focus of object-oriented programming technology is wholly different than that of procedural programming technology. The focus of procedural-based design is on the overall process used to solve the problem; whereas the focus of object-oriented design is on casting the problem as a set of autonomous entities that can work together to provide a solution. The autonomous entities of object-oriented technology are, of course, objects. Object-oriented technology is significantly different from procedural technology because problems are broken down into sets of cooperating objects instead of into hierarchies of nested computer programs or procedures. Thus, a pure object-oriented program is made up of code entities called objects. Each object is an identifiable, encapsulated piece of code and data that provides one or more services when requested by a client. Conceptually, an object has two parts, an external object interface and internal object implementation. In particular, all object implementation functions are encapsulated by the object interface such that other objects must communicate with that object through its object interface. The only way to retrieve, process or otherwise operate on the object is through the methods defined on the object. This protects the internal data portion of the object from outside tampering. Additionally, because outside objects have no access to the internal implementation, that internal implementation can change without affecting other aspects of the program.

In this way, the object system isolates the requester of services (client objects) from the providers of services (server objects) by a well defined encapsulating interface. In the classic object model, a client object sends request messages to server objects to perform any necessary or desired function. The message identifies a specific method to be performed by the server object, and also supplies any required parameters. The server object receives and interprets the message, and can then decide what service to perform.

There are many computer languages available today that support object-oriented programming. For example, Smalltalk, Object Pascal, C++ and JAVA are all examples of languages that support object-oriented programming to one degree or another.

The present invention is described with reference to the Java programming language. For this reason, this description will utilize the nomenclature of Java. The following Java nomenclature is used frequently throughout the description and will be described herein briefly. A class is a grouping of instance variables and methods that is used to describe the behavior of an object. In general, a class is a software construct that defines the data (state) and methods (behavior) of the specific concrete objects that are subsequently constructed from that class. In Java terminology, a class is built out of members, which are either fields or methods. Fields are the data for the class. Methods are the sequences of statements that operate on the data. Fields are normally specific to an object that is, every object constructed from the class definition will have its own copy of the field. Such fields are known as instance variables. Similarly, methods are also normally declared to operate on the instance variables of the class, and are thus known as instance methods. An object is an instance of a class. An instance variable is the data of an object that is instantiated from a class. A static instance variable is one that will be the same for all instances of the class. A non-static instance variable varies for each instance of the class. Constant data refers to data that is not altered during program execution.

A method or function is a program segment that performs a well-defined series of operations. In Java, a method is implemented by instructions represented as a stream of byte codes. A byte code is an 8-bit code that can be a portion of an instruction such as an 8-bit operand or opcode. An interface is an abstract class where the byte codes that implement the method are defined at runtime. A Java application is an executable module consisting of byte codes that can be executed using the Java interpreter or the Java just-in-time compiler. A more detailed description of the features of the Java programming language is described in Tim Ritchey, Programming with Java Beta 2.0, New Riders Publishing (1995).

Java is a modern object-oriented programming language designed by Sun Microsystems that has grown in popularity in recent years. Java offers many features and advantages that makes it a desirable programming language to use. First, Java is specifically designed to create small application programs, commonly called “applets”, that can reside on the network in centralized servers, and which are delivered to the client machine only when needed. Second, Java is completely platform independent. A Java program can be written once and can then run on any type of platform that contains a Java Virtual Machine, also abbreviated as JVM. The JVM model is supported by most computer vendors, thereby allowing a software vendor to have access to hardware and software systems produced by many different companies. Finally, Java is an object-oriented language, meaning that software written in Java can take advantage of the benefits of object-oriented programming techniques. As in other object-oriented systems, operations in Java are performed by one object calling a method on another object. These objects can reside locally on the same machine or on separate JVM's physically located on separate computers or systems.

A “Java process”0 can be defined as a set of threads which is kept together by a structure called the thread group (java.lang.ThreadGroup).

The “class name space”0 of a process is defined by the class loader that loaded the initial application class, i.e. the class containing the applications main( ) method. A class loader's class name space contains classes loaded by itself and all or a subset of the classes loaded by its parent class loader. For example, the class name space of an application class loader could contain application classes plus the classes of the core Java libraries loaded by the JVM's system class loader.

A thread can only access objects which are in the object closure of the threads executing in the same thread group. The “process boundary”0 is defined by this object closure, also called the process object closure. A process object closure encompasses all objects created during the execution of one of the process' threads and still referenced from the execution stack., i.e., referenced by a method local variable. Recursively, it contains all objects referenced by objects of the object closure. It contains further all objects which are referenced from static fields of classes in the process' class name space.

When the word “process” is mentioned in the following, then it refers to a Java process as mentioned above.

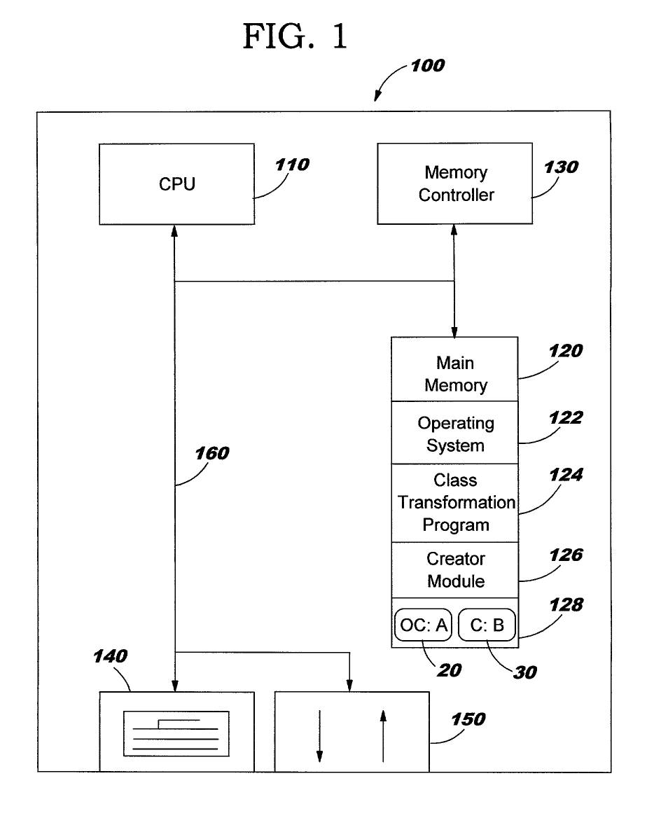

In order to aid in the understanding of the present invention, FIG. 1 shows a high-level block diagram of a computer 100 in which a class may be transformed according to the present invention. However, those skilled in the art will appreciate that the method and apparatus of the present invention apply equally to any computer or computer system, regardless of whether the computer system is a complicated multi-user computing apparatus or a single user device such as a personal computer or workstation. The computer 100 suitably comprises a processor 110, a main memory 120, a memory controller 130, a storage device or interface 140, and a terminal interface 150, all of which are interconnected via a system bus 160. Various modifications, additions, or deletions may be made to the computer 100 illustrated in FIG. 1 within the scope of the present invention such as the addition of cache memory or other peripheral devices. The processor 110 performs computation and control functions of the computer 100 and comprises a suitable central processing unit (CPU). The processor 110 may comprise a single integrated circuit, such as a microprocessor, or may comprise any suitable number of integrated circuit devices and/or circuit boards working in cooperation to accomplish the functions of a processor. The processor 110 suitably executes programs or instructions within the main memory 120. The storage device 140 allows the computer 100 to store and retrieve information. The memory controller 130, through use of a processor (not shown) separate from the processor 110, is responsible for moving requested information from the main memory 120 and/or through the storage device 140 to the processor 110. While for the purposes of explanation, the memory controller 130 is shown as a separate entity, those skilled in the art understand that, in practice, portions of the function provided by the memory controller 130 may actually reside in the circuitry associated with the processor 110, the main memory 120, and/or the storage device 140. The terminal interface 150 allows the computer 100 to communicate with other computers or devices. Although the computer 100 depicted in FIG. 1 contains only a single main processor 110 and a single system bus 160, it should be understood that the present invention applies equally to computer systems having multiple processors and multiple system buses. Similarly, although the system bus 160 of the preferred embodiment is a typical hardwired, multidrop bus, any connection means that supports bi-directional communication in a computer-related environment could be used. The main memory 120 suitably contains an operating system 122, a class transformation program 124, a creator module 126, and a Java byte code program 128 comprising an original class 20 and a class 30. The creator module 126 is created and/or manipulated by some portion of the class transformation program 124. The term “memory”0 as used herein refers to any storage location in the virtual memory space of the computer 100. It should be understood that the main memory 120 will not necessarily contain all parts of all mechanisms shown. For example, portions of the class transformation program 124 and operating system 122 may be loaded into an instruction cache (not shown) for processor 110 to execute, while other files may well be stored on magnetic or optical disk storage devices (not shown). In addition, although the class transformation program 124 is shown to reside in the same memory location as the operating system 122, the creator module 126, and the Java byte code program 128, it is to be understood that the main memory 120 may consist of multiple disparate memory locations.

The structure of the computer 100, as described with reference to FIG. 1, is to be seen as the underlying device that can be used to transform a class as described in the following embodiment.

Referring now to FIG. 2, where a schematic diagram of transforming a class according to the present invention is shown. FIG. 2 depicts two classes, an original class 20 and a class 30. The original class 20 comprises here two class fields 2 and an original-class class-initialization method 3 whilst the class 30 comprises here two usage methods 5 which have accesses 42, 43 to the class fields 2. These usage methods 5, also called static or class methods, can be instance methods. A first process 50 and a second process 60 are executed by use of a class loader 40 after the transformation. The first process 50 comprises a first instance 51 with instance fields 12, and the second process 60 comprises a second instance 61 with instance fields 12.

On the one hand, the original class 20 is transformed to a helper class 21, as indicated by the arrow labeled with “a”, and on the other hand the original class 20 is transformed to a modified-original class 22. The class 30 is transformed to a corresponding modified class 31, as indicated by the arrow labeled with “b”. As indicated by the dashed lines labeled with “i.”, each class field 2 is converted to an instance field 12 and introduced into the helper class 21. Furthermore, the original-class class-initialization method 3 is converted to a helper-class instance-initialization method 13, as indicated by the dashed line labeled with “ii.”. The helper-class 21 comprises a class-initialization method 14 that is able to create a table 15, e.g. a hash table 15. Instead of the hash table 15, any structure that provides a mapping from a process or a process identifier to an instance of the helper class 21 might be used.

In the modified-original class 22, each class field 2 is replaced by an access function 23, 24, 25, 26, for example, by a read access function 23, 25 and/or a write access function 24, 26.

The usage methods 5 from the class 30 are converted to modified-usage methods 6, as indicated by the broken line, whereby each former access 42, 43 to one class field 2 is replaced by an invocation 33, 36 of the respective access function 23, 24, 25, 26. This invocation 33, 36 is able to fetch from the instances 51, 61 of the helper class 21, which are assigned to the processes 50, 60, the respective instance field 12. The instance fields 12 correspond to the class fields 2.

After the transformation, the helper class 21, the modified-original class 22 and the modified class 31 are loaded by the class loader 40 in order to run the processes 50, 60.

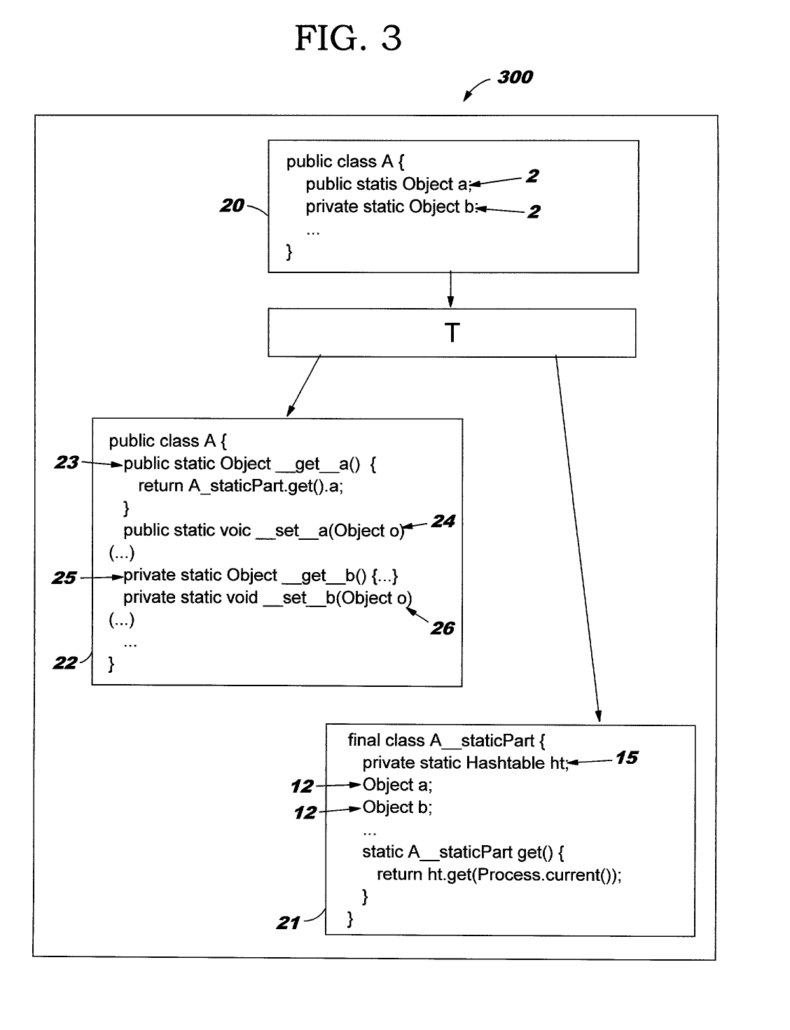

Some implementation details are described with reference to FIG. 3 to 7 where the same reference numbers are used for the same elements.

FIG. 3 shows the transformation, indicated by the box labeled with “T”, of a sample code 300 applied to a normal class where the original class 20 is transformed to the helper class 21 and the modified-original class 22. The helper class 21 can be regarded as the static-part of the original class 20 whilst the modified-original class 22 as the non-static part of the original class 20. It can be seen that class fields 2, also referred to as static fields, of the original class 20 (A.a and A.b) show up as instance fields 12 in the helper class 21 (A_staticPart.a and A_staticPart.b).

The hash table 15 (A_staticpart.ht) is used to retrieve the instance 51, 61 of the helper class 21 that corresponds to the current process 50, 60. It is the only static field in any application class. It can not be used to bypass the process boundary because it is accessible only from within the helper class 21 (A_staticPart) in which it is declared private (access modifier private). In general, helper classes 21 are generated by the class transformation T which prevents user manipulations. The class-initialization method 14, also referred to as constructor, (not shown in the figure) registers all instances of the helper class 21 within the hash table 15. This ensures that there will be exactly one instance per process 50, 60. The hash table 15 provides thus the mapping from processes 50, 60 to their corresponding process-global variables.

In the original class 20, the initialization of the class fields 2 is done in the original-class class-initialization method 3 or short class initializer method 3 (A.<clinit>( )) (not shown in the figure). The transformation moves this functionality to the constructor method also called helper-class instance initialization method 13 of the helper class 21 (A_staticPart.<init>( )) (not shown in the figure). This should be done because the transformed class fields 2 need to be initialized once per process in contrast to the one time initialization during class loading. The helper-class instance initialization method 13 of the helper class 21 is declared with a private access flag to prevent abuse. It is executed if the method A_staticPart.get( ) cannot find an instance for the current process in the hash table 15. This guarantees that the transformed class fields 2 are correctly initialized before their first use. In cases where the class initializer method 3 (A.<clinit>( )) has side effects on class fields 2 of other classes it might be that the class initialization does not happen in the usual order or not at all. To prevent this, it should be provided that all classes whose <clinit>( ) are more complex than just initializing class fields 2 with constant values are executed on process startup in the same order as it would happen for the original classes 20.

In the modified-original class 22, for each class field 2 access functions 23, 24, 25, 26 are added, e.g., A._get a( ) as a read function 23 and A._set_a( )as a write function 24 replace the class field 2 (A.a). These access functions 23, 24 are used to access the displaced fields. The access modifiers assigned to the class fields 2 in the original class 20, e.g. public for A.a and private for A.b, are assigned to the corresponding access functions 23, 24. For class fields 2 that were declared to be constant (access modifier final), the_set_*( ) method is left out. This guarantees the original semantics.

An example of an implementation of the read access function 23 A._get_a( ) is shown in FIG. 3. It uses the method A_staticPart.get( ) to retrieve the corresponding instance of the helper class 21 and then selects and returns the field A_staticPart.a for which the method is a replacement. The implementation of the method A._set_a( ) differs only in the sense that it makes an assignment and returns a void.

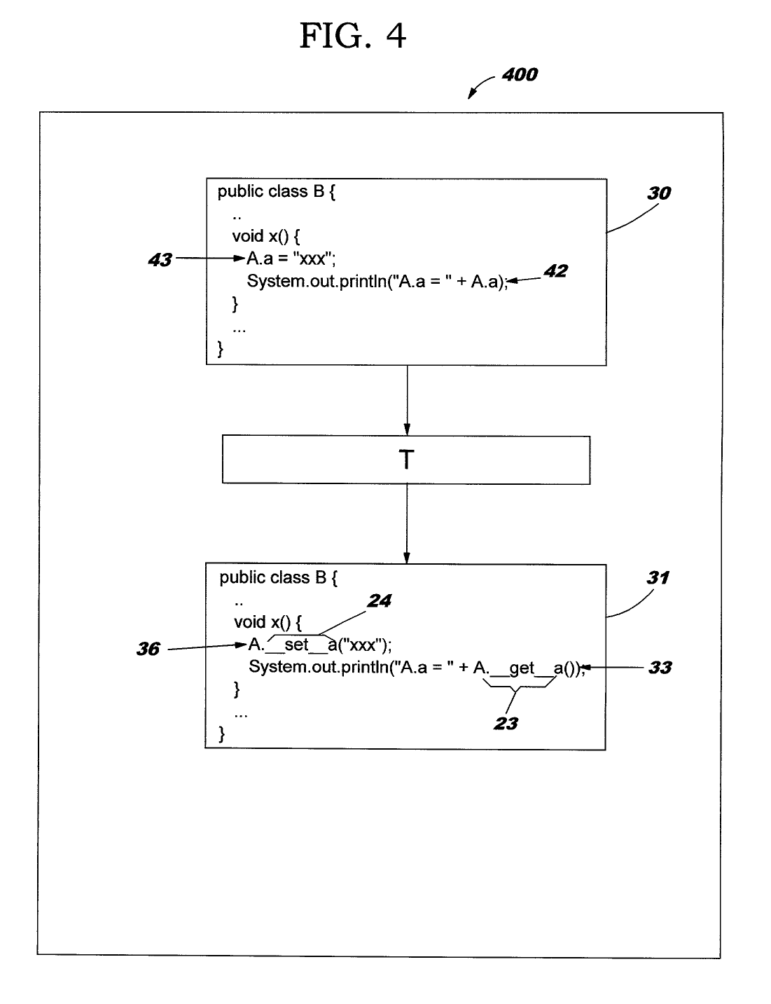

The removal of the class fields 2 needs to be reflected in all classes 20, 30 that access the class fields 2. FIG. 4 shows the transformations, indicated by the box labeled with “T”, of a sample code 400 applied on an example method 5, method B.x( ). The write access 43 of the class field 2 is replaced with an invocation 36 of a write access function 24 A._set_a( ) and the read access 42 is replaced with an invocation 33 of the read access function 23 A._get_a( )within the modified class 31.

In the byte code this translates to replacing the byte code operations GETSTATIC and PUTSTATIC with an INVOKESTATIC byte code operation of the corresponding access function 23, 24, 25, 26. The following Table 1 summarizes the general transformations applied to the original class.

TABLE 1

| | After Transformation | |
|---|---|---|
| Before Transformation | modified-original | |
| original class | class | helper-class |
| class name A | class name A | class name |
| | | A__staticPart |
| class field a | access functions | instance field a |
| | _get_a() and | |
| | _set_a() | |
| field access modifiers | method access | field access modifier |
| | modifiers | |
| public, protected, | public, protected, | n/a |
| private | private | |
| final, transient, | n/a | final, transient, |
| volatile | | volatile |
| class initialization | n/a | constructor <init>() |
| method <clinit>() | | |
| access to class field | method invocation | n/a |
| within a method | | |
| GETSTATIC A.a | INVOKESTATIC | |
| | _get_a() | |
| PUTSTATIC A.a | INVOKESTATIC | |
| | _set_a() | |

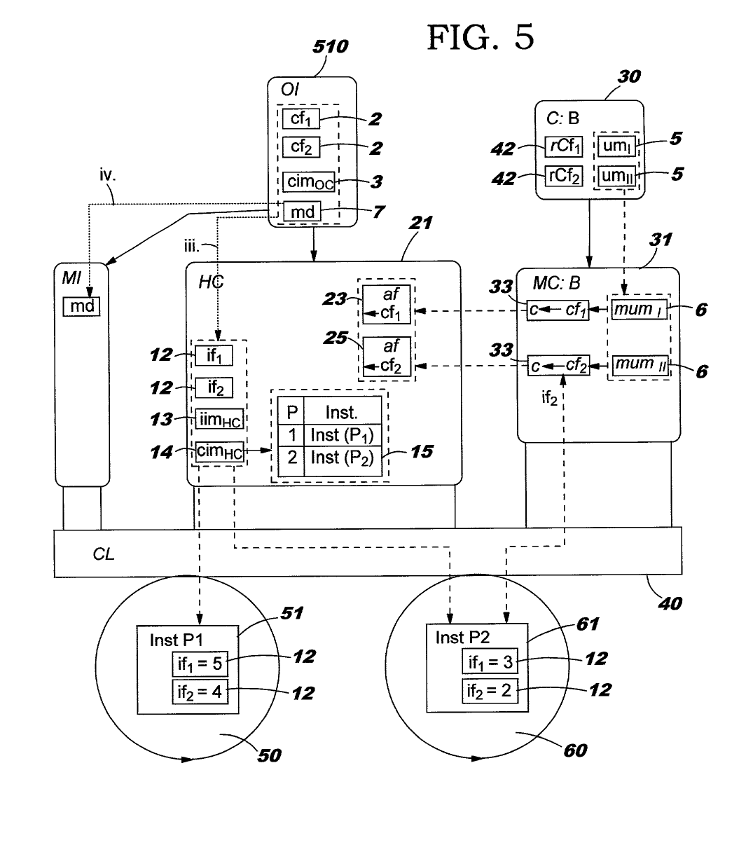

FIG. 5 illustrates a schematic diagram of a transformation applied to an original interface or interface 510. Compared to FIG. 2, slightly different transformations are applied to interfaces 510. FIG. 5 depicts the interface 510 and the class 30. The interface 510 comprises here two class fields 2, the original-interface class-initialization method 3, and a method declaration 7. The method declaration 7 has no body and contains only the signature of a method, i.e. the method name and types of arguments and the types of the return value. The class 30, on the other hand, comprises here two usage methods 5 which have access 42 to the class fields 2. These usage methods 5 can also be instance methods. The first process 50 and the second process 60 are executed by use of the class loader 40 after the transformation. The first process 50 comprises the first instance 51 with instance fields 12, and the second process 60 comprises the second instance 61 with instance fields 12.

On the one hand the interface 510 is transformed to a helper class 21 and on the other hand the interface 510 is transformed to a modified interface 511. The class 30 is transformed to the corresponding modified class 31. As indicated by the dashed line labeled with “iii.”, each class field 2 is converted to an instance field 12, the original-interface class-initialization method 3 is converted to a helper-class instance-initialization method 13, and all converted elements are introduced into the helper class 21. Moreover, the class-initialization method 14 is created and introduced into the helper-class 21 whereby this class-initialization method 14 is able to create the hash table 15. As indicated by the dashed line labeled with “iv.”, the method declaration 7 is introduced into the modified interface 511 without any modifications.

In the helper class 21 for each class field 2 of the original interface 510, the corresponding access function 23, 25 is introduced. For example, this may be the read access function 23, 25.

The usage methods 5 from the class 30 are converted to modified-usage methods 6, as indicated by the broken line, whereby each former access 42 to one class field 2 is replaced by an invocation 33 of the respective access function 23, 25. This invocation 33 is able to fetch from the instances 51, 61 of the helper class 21, which are assigned to the processes 60, 61, the respective instance field 12. The instance fields 12 correspond to the class fields 2.

After the transformation, the modified interface 511, the helper class 21, and the modified class 31 are loaded by the class loader 40 in order to run the processes 50, 60.

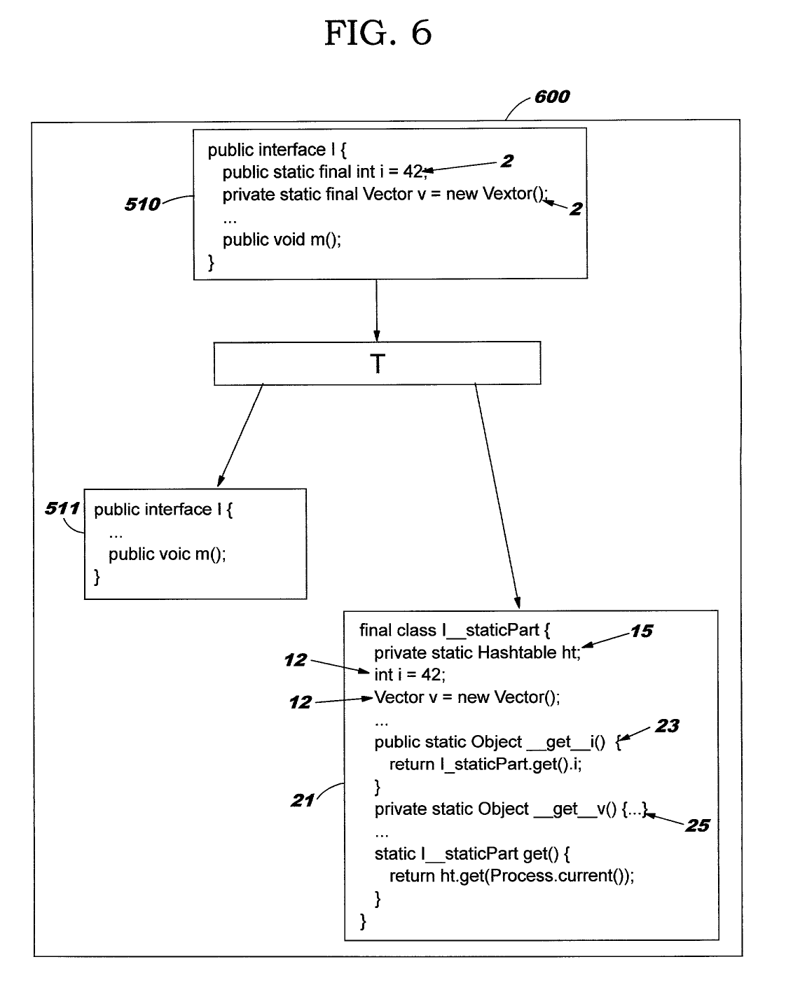

A transformation T of a sample code 600 applied to the interface 510 is indicated in FIG. 6. Interface fields are implicitly declared public, static and final, i.e., one can not reassign new values to them. For basic types, e.g., int, double etc., this means the values are constant and thus do not affect the isolation property. However, it is assumed that in general more complex field types are used, for example a Vector, as indicated with field I.v in FIG. 6. Such a class field 2 could be used to exchange references across process boundaries. Thus interface fields, which are always class fields 2, also have to be moved into the helper-class 21, as indicated in FIG. 6. Usually, interface fields comprising constants are initialized at the very beginning and can only be read. For interfaces 510 the modified class is also an interface, here called modified interface 511, but the helper class 21 is a normal class.

A problem that appears is that interfaces 510 can contain only method declarations 7 but no method implementations. Therefore, the access functions should be moved into the helper class 21 rather than into the modified interface 511, as shown in FIG. 5 and 6. By doing so, the field access controls cannot be bypassed, because all interface fields are declared public, as mentioned before.

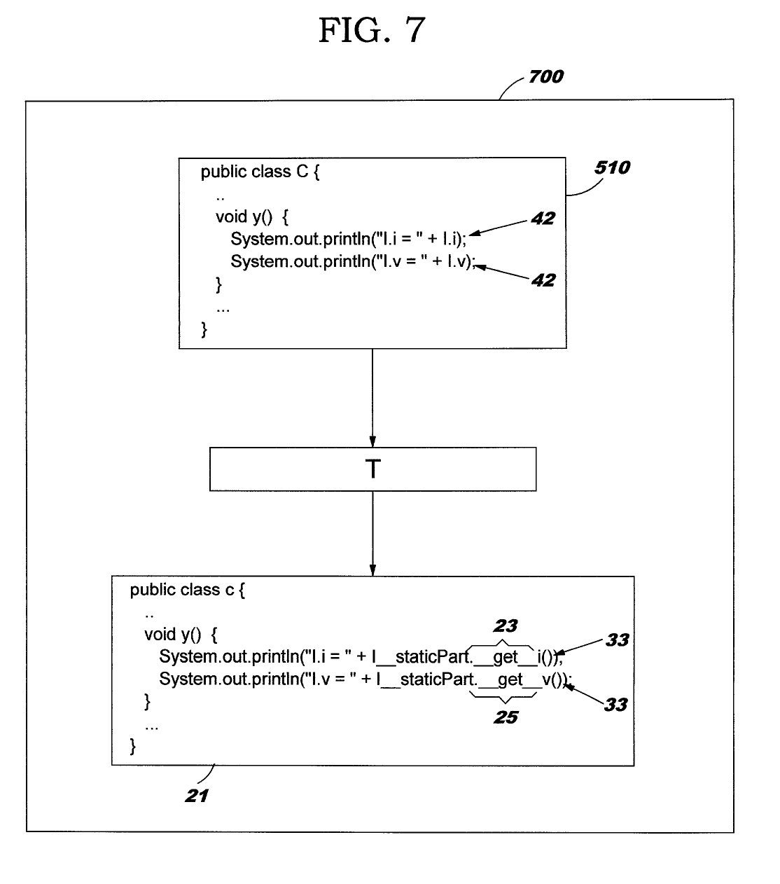

FIG. 7 exemplifies the transformation T of a sample code 700 applied to accesses 42 to class fields 2 of the interface 510. In contrast to FIG. 4, the access functions 23, 25 are invoked by the invocation 33 at the helper class 21, e.g. I_staticPart._get_i( ).

Table 2 summarizes the rules for the transformations that are specific to interfaces or interface classes.

TABLE 2

| Before | | |
|---|---|---|
| Transformation | After Transformation | |
| Original Interface | modified interface | helper class |
| interface name B | interface name B | class name B_staticPart |
| class field c | | instance field c plus |
| | | static methods_get_c() |

The present invention can be realized in hardware, software, or a combination of hardware and software. Any kind of computer system, or other apparatus adapted for carrying out the method described herein, is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system, is able to carry out these methods.

Computer program means or computer program in the present context mean any expression, in any language, code or notation, of a set of instructions intended to cause a system having an information processing capability to perform a particular function either directly or after either or both of (a) conversion to another language, code or notation, and (b) reproduction in a different material form.

Although the present invention has been described with respect to a specific preferred embodiment thereof, various changes and modifications may be suggested to one skilled in the art and it is intended that the present invention encompass such changes and modifications as fall within the scope of the appended claims.

1. A method of transforming a class, comprising a usage method accessing at least one class field, said class being loadable by a class loader in an object-oriented environment, said method comprising the steps of:
(a) creating from an original class, which comprises a class field, an original-class class-initialization method, and a helper class, by
i) converting at least one said class field to an instance field and introducing the instance field into said helper class; and
ii) converting the original-class class-initialization method to a helper-class instance-initialization method and introducing it into said helper class which comprises a helper-class class-initialization method; and
(b) creating for the class a corresponding modified class by converting the usage method to a modified-usage method, wherein each access to the class field is replaced by an invocation of an access function for fetching, for a process with an instance of the helper class, from the instance, the instance field corresponding to the class field,
the helper class and the modified class being loadable the class loader.

2. The method according to claim 1, further comprising the steps of:
(c) creating, for the original class, a corresponding modified-original class; and
(d) converting each original-usage method of the original class to a modified original-usage method and introducing it into said modified-original class, wherein each access to said class field is replaced by an invocation of the access function for fetching, for a process with an instance of said helper class, from the instance, the instance field corresponding to the class field.

3. The method according to claim 2, wherein said creating step (c) comprises creating, for each class field in the original class, at least one of an access function, a read access function and a write access function.

4. The method according to claim 1, wherein the original class is transformed into one helper class.

5. The method according to claim 1, wherein the original class is transformed into one modified class.

6. The method according to claim 1, wherein transforming the class is applied to a byte code.

7. The method according to claim 1, further comprising the step of loading the helper class and the modified class by use of the class loader when one of the processes is started.

8. The method according to claim 1, wherein said converting substep (ii) further comprises introducing the original-class class-initialization method into the modified-original class and replacing the original-class class-initialization by an empty method.

9. The method according to claim 1, wherein the helper-class class-initialization method creates a table.

10. The method according to claim 1, further comprising the step of transforming an original interface, comprising at least one class field and/or an original-interface class-initialization method, into a modified interface and the helper class, comprising the substeps of:
(i) converting at least one said class field to an instance field and introducing it into the helper class; and
(ii) converting the original-interface class-initialization method to a helper-class instance-initialization method and introducing it into the helper class which comprises a helper-class class-initialization method,
wherein the helper class and the modified interface are loadable by the class loader.

11. Computer readable code stored on computer readable media for transforming a class in an object-oriented environment, comprising:
a first process for creating from an original class, which comprises a class field, an original-class class-initialization method, and a helper class, said first process comprising
first subprocessess for converting at least one said class field to an instance field and introducing the instance field into the helper class; and
second subprocesses for converting the original-class class-initialization method to a helper-class instance-initialization method and introducing it into the helper class which comprises a helper-class class-initialization method; and
a second process for creating for the class a corresponding modified class by converting the usage method to a modified-usage method, wherein each access to the class field is replaced by an invocation of an access function for fetching, for a process with an instance of the helper class, from the instance, the instance field corresponding to the class field,
the helper class and the modified class being loadable the class loader.

12. In a computing environment, a system for class transformation, said system comprising:
a class comprising at least one class field, an original-class class-initialization method, and a usage method accessing at least one of the class fields, said class residing in memory; and
a creator module for creating, out of said class, a helper class and a modified class,
wherein at least one said class fields is convertable to an instance field into said helper class, wherein said original-class class-initialization method is convertable to a helper-class instance-initialization method into said helper class which comprises a helper-class class-initialization method, and wherein in said usage method in said modified class each access to said class field is replaceable by an invocation of an access function for fetching the instance field corresponding to the class field for a process with an instance of said helper class, from said instance, and wherein said helper class and said modified class are loadable by a class loader.
